(19) United States
(12) Patent Application Publication
(10) Pub. No.: US 2026/0070570 A1
(43) Pub. Date: Mar. 12, 2026

(54) VEHICLE CONTROL DEVICE AND EXTERNAL DEVICE

(71) Applicant: TOYOTA JIDOSHA KABUSHIKI KAISHA, Toyota-shi (JP)

(72) Inventor: Toshiki KINOSHITA, Toyota-shi (JP)

(73) Assignee: TOYOTA JIDOSHA KABUSHIKI KAISHA, Toyota-shi (JP)

(21) Appl. No.: 19/189,600

(22) Filed: Apr. 25, 2025

(30) Foreign Application Priority Data
Sep. 12, 2024 (JP) 2024-158287

(51) Int. Cl. B60W 50/06; B60W 30/09; B60W 50/14

(52) U.S. Cl. CPC B60W 50/06; B60W 30/09; B60W 50/14; B60W 2556/50

(57) ABSTRACT

A vehicle control ECU includes: a controller configured to perform automatic braking when the controller determines that the risk of collision between an object and a host vehicle is equal to or higher than an automatic braking threshold; and a communication device configured to communicate with an external device located outside the host vehicle. The vehicle control ECU receives specific point-related information from the external device via the communication device. The specific point-related information is information identifying a point where the automatic braking has been performed in the past and having a correlation with a level of possibility that the automatic braking is newly performed at the point. When the host vehicle approaches the point identified by the specific point-related information, the vehicle control ECU performs either first control or second control according to the specific point-related information.

### CROSS-REFERENCE TO RELATED APPLICATION

This application claims priority to Japanese Patent Application No. 2024-158287 filed on Sep. 12, 2024. The disclosure of the above-identified application, including the specification, drawings, and claims, is incorporated by reference herein in its entirety.

### BACKGROUND

### 1. Technical Field

The present disclosure relates to vehicle control devices that perform automatic braking for avoiding a collision between a host vehicle and an object, and external devices that communicate with a vehicle configured to perform the automatic braking.

### 2. Description of Related Art

When a host vehicle equipped with a conventional device shows a danger avoidance behavior to avoid a collision with a surrounding moving object, the device transmits information on the danger avoidance behavior and the location of the host vehicle to a server. The server accumulates the information transmitted from the host vehicle. The server transmits a frequent danger avoidance or accident point to the host vehicle based on the accumulated information. The host vehicle provides an alert and route guidance (hereinafter referred to as “alert etc.”) when the location of the host vehicle falls within a certain distance from the frequent danger avoidance or accident point transmitted from the server (see Japanese Unexamined Patent Application Publication No. 2023-146712 (JP 2023-146712 A)).

### SUMMARY

However, since the above technique does not consider the frequency of occurrence of the danger avoidance behavior, an alert etc. is provided even when the host vehicle approaches a point that is not necessarily dangerous. Therefore, occupants of the host vehicle including the driver are highly likely to be annoyed by the alert etc.

The present disclosure was made to solve this issue. One object of the present disclosure is to provide a vehicle control device that can perform beneficial control so as not to frequently bother an occupant of a host vehicle, when the host vehicle approaches near a “point where the host vehicle and/or other vehicles have performed automatic braking for collision avoidance in the past.”

An aspect of a vehicle control device of the present disclosure is a vehicle control device including
a controller (10) configured to acquire object information indicating a relative relationship between an object located in a direction of travel of a host vehicle and the host vehicle and to perform automatic braking (S640) when the controller determines, based on the object information, that a risk of collision between the host vehicle and the object is equal to or higher than an automatic braking threshold (S635: Yes), and
a communication device (80) configured to communicate with an external device (100) located outside the host vehicle.
   The controller is configured to receive specific point-related information (information identifying a frequent activation point or information identifying a frequent activation candidate point) from the external device via the communication device (S430). The specific point-related information is information identifying a point where the automatic braking was performed in the past and having a correlation with a level of possibility that the automatic braking is newly performed at the point.
   The controller is configured to, when the host vehicle approaches the point identified by the specific point-related information (S440: Yes), perform either first control (S480) or second control (S480 and S470) according to the specific point-related information.

In this case, the first control may be auxiliary control that is performed when the level of possibility that the automatic braking is newly performed as indicated by the specific point-related information is equal to or higher than a first level. The auxiliary control may be control for reducing the amount of time from when an instruction to perform the automatic braking is transmitted to a braking device of the host vehicle until a braking force actually starts to be applied to the host vehicle. More specifically, when the braking device is a friction braking device configured to be driven by the hydraulic pressure of a brake fluid, the auxiliary control may be control to increase the hydraulic pressure of the brake fluid to such an extent that a braking force from the friction braking device is not applied to the host vehicle (pre-pressurization of the brake fluid: S480). The second control may be control including both the auxiliary control and control to notify an occupant of the host vehicle that the host vehicle is approaching a dangerous point (S470).

With the above configuration, the first control or the second control is performed according to the level of possibility that the automatic braking is newly performed. Therefore, by setting the first control and the second control to such appropriate control as described above, it is possible to perform beneficial control so as not to frequently bother the occupant of the host vehicle.

An aspect of an external device (100) of the present disclosure is an external device including an information storage device (100b) and a server (100a) configured to transmit and receive information to and from a vehicle by communication.

The server is configured to receive first information (PCS activation information) from the vehicle (S205). The first information is information identifying a point where automatic braking for avoiding a collision between the vehicle and an object located in a direction of travel of the vehicle was performed by the vehicle.

The server is configured to
register, in the information storage device, the point identified by the received first information as a frequent activation candidate point (S255),
when the first information is newly received and a predetermined number or more of the frequent activation candidate points have already been registered within a predetermined range near the point where the automatic braking was performed as identified by the newly received first information (S235: Yes, S250: Yes), register, in the information storage device, the point where the automatic braking was performed as identified by the newly received first information as a frequent activation point (S245), and
transmit the registered frequent activation candidate point and the registered frequent activation point to the vehicle (in response to a request from the vehicle) (S430).

The server may be configured to
when the first information is newly received and a point where an accident occurred in the past is determined to be present within the range near the point where the automatic braking was performed as identified by the newly received first information (S240: Yes), register, in the information storage device, the point where the automatic braking was performed as identified by the newly received first information as the frequent activation point (S245).

With this configuration, the external device can appropriately register a frequent activation candidate point and a frequent activation point, and can provide information on these points to the vehicle.

In the above description, in order to facilitate understanding of the present disclosure, names and/or signs used in the following embodiment are added in parentheses to the configurations of the disclosure corresponding to those of the embodiment. However, the components of the present disclosure are not limited to those of the embodiment defined by the names and/or signs. The present disclosure also encompasses an external device configured to communicate with a vehicle, a vehicle control method, a method for providing information to a vehicle, and a program for these.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle control device according to an embodiment of the present disclosure;

FIG. 2 is a routine that is executed by a server of an external device shown in FIG. 1;

FIG. 3 is part of a routine that is executed by the server of the external device shown in FIG. 1;

FIG. 4 is a routine that is executed by a CPU of a vehicle control ECU shown in FIG. 1;

FIG. 5 is a routine that is executed by the CPU of the vehicle control ECU shown in FIG. 1; and

FIG. 6 is a routine that is executed by the CPU of the vehicle control ECU shown in FIG. 1.

### DETAILED DESCRIPTION OF EMBODIMENTS

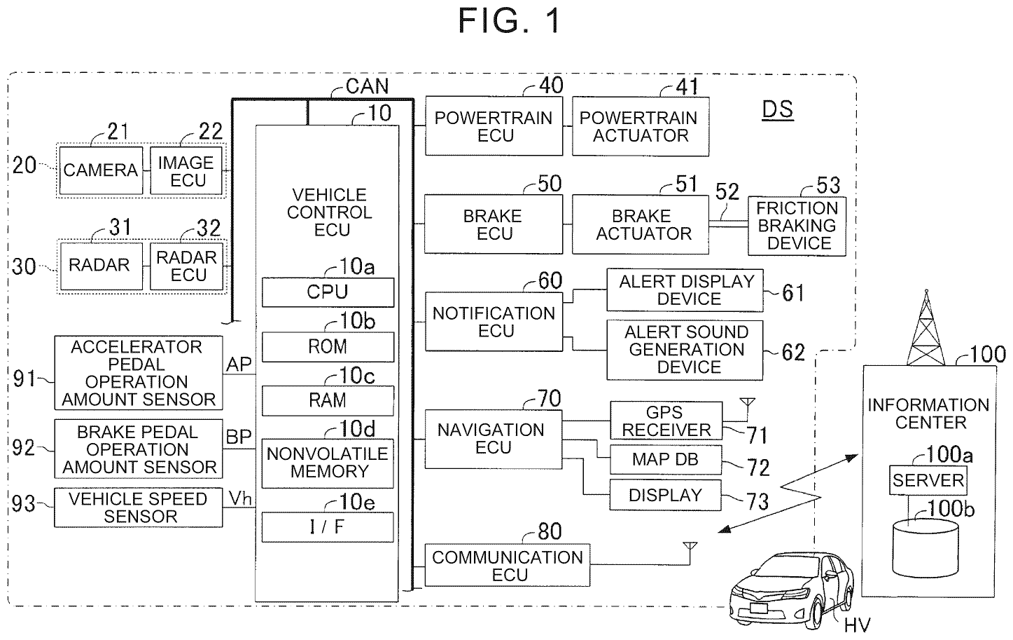

The “vehicle control device DS (device DS)” according to an embodiment of the present disclosure includes the components shown in FIG. 1, is mounted on a host vehicle HV, and is applied to the host vehicle HV. The host vehicle HV may be any of a vehicle using an internal combustion engine as a power source, a battery electric vehicle, a hybrid electric vehicle, etc.

As used herein, the term “ECU” is an electronic control unit. The ECU includes a microcomputer including a CPU (processor), a ROM, a RAM, and an interface. The ECU is also referred to as a controller or a computer. A plurality of ECUs shown in FIG. 1 is connected to each other through a CAN (Controller Area Network) so as to transmit and receive information to and from each other. Part or all of these ECUs may be integrated into one ECU.

A vehicle control (driver assistance) ECU 10 performs “collision avoidance assist control including automatic braking (i.e., collision damage mitigation control)” for reducing the possibility that the host vehicle HV collides with an object.

The camera device 20 includes a camera 21 and an image ECU 22. Every time a predetermined time elapses, the camera 21 captures a scene ahead of the host vehicle HV to acquire image data. The image ECU 22 generates camera information based on the image data from the camera 21, and transmits the camera information to the vehicle control ECU 10. The camera information includes camera object information and lane information. The camera object information includes the position of an object with respect to the host vehicle HV and the type of the object.

The radar device 30 is a device that acquires information on an object present ahead of the host vehicle HV by using radio waves in a millimeter-wave band. The radar device 30 includes a radar 31 and a radar ECU 32. Every time a predetermined time elapses, the radar 31 transmits a millimeter wave within a detection range ahead of the vehicle, and receives the millimeter wave reflected by the object. The radar 31 transmits information on the transmitted and received millimeter wave to the radar ECU 32. The radar ECU 32 acquires radar information based on information from the radar 31. The radar ECU 32 transmits the radar information to the vehicle control ECU 10. The radar information includes the distance to the object, the orientation of the object, and the relative velocity of the object.

The vehicle control ECU 10 generates fusion object information by integrating the radar information and the camera information. The fusion object information is object information representing the relative relationship between the host vehicle HV and an object located in the direction of travel of the host vehicle HV. The fusion object information includes the distance L(n) from the host vehicle HV to an object n, the orientation of the object n with respect to the host vehicle HV, the relative velocity Vr(n) of the object n with respect to the host vehicle HV, and the type of the object n. The camera device 20 and the radar device 30 may be referred to as a “surrounding object detection device (surroundings monitoring device)” that detects an object located around the host vehicle.

A powertrain ECU 40 drives a powertrain actuator 41 to control a driving device, not shown, including a power source of the host vehicle HV, thereby generating a driving force.

A brake ECU 50 drives a brake actuator 51 to control the pressure of a brake fluid in an oil passage 52 and a hydraulic friction braking device 53, thereby applying a braking force to the host vehicle HV. The brake ECU 50 can perform automatic braking for automatically applying a braking force to the host vehicle HV in order to avoid a collision between the host vehicle HV and an object, based on an instruction from the vehicle control ECU 10. This automatic braking is also referred to as “AEB (Automatic Emergency Brake).”

A notification (alert) ECU 60 causes an alert display device 61 in front of the driver's seat to display a predetermined pattern and causes the alert sound generation device 62 to generate an alert sound, based on an instruction from the vehicle control ECU 10.

A navigation ECU 70, together with a GPS receiver 71, a map data storage device 72 storing map data, and a display touch panel 73, forms an in-vehicle navigation system. The navigation ECU 70 acquires the current location of the host vehicle HV based on a GPS signal received by the GPS receiver 71. The current location of the host vehicle HV is represented by a latitude and a longitude.

A communication ECU 80 communicates with an external device located outside the host vehicle HV (for example, an information center 100) by wireless communication and a network, and transmits and receives various kinds of information to and from the external device.

The vehicle control ECU 10 receives detected values (output values) from the following “sensors and switches”:
an accelerator pedal operation amount sensor 91 that detects an accelerator pedal operation amount AP,
a brake pedal operation amount sensor 92 that detects a brake pedal operation amount BP, and
a vehicle speed sensor 93 that detects a speed (that is, a host vehicle speed) Vh of the host vehicle HV.

The information center 100 includes a server 100a and an information storage device 100b. The server 100a can transmit and receive various kinds of information to and from the device DS by communicating with the communication ECU 80. The server 100a stores information in the information storage device 100b and reads information from the information storage device 100b. The information storage device 100b stores various kinds of information, map information, and traffic accident statistical data, which will be described later. The traffic accident statistical data is data that identifies a “point where a traffic accident actually occurred” provided by a specific government agency by the latitude and longitude of the point.

### Overview of Operation

A vehicle equipped with the device DS (host vehicle HV and other vehicles) will be hereinafter referred to as “device-mounted vehicle.” The device-mounted vehicle provides an alert for collision avoidance when an alert condition that is satisfied when a collision risk reaches an alert threshold is satisfied, and perform automatic braking when an automatic braking condition that is satisfied when the collision risk reaches an automatic braking threshold higher than the alert threshold is satisfied. This control to perform such alerting and automatic braking is referred to as collision avoidance control or PCS (i.e., pre-crash safety) control. The collision risk is represented by, for example, a time to collision TTC described later.

When an alert of the PCS control is provided and then ended, the device-mounted vehicle transmits PCS activation information to the server 100a. The PCS activation information includes the following information. An activation point is represented by a latitude and a longitude.

An alert activation point that is the location of the device-mounted vehicle when the alert of the PCS control was started.
Alert activation date and time that is the date and time when the alert of the PCS control was started.
An alert start vehicle speed VhAL that is the vehicle speed of the device-mounted vehicle when the alert of the PCS control was started, and an alert threshold time TALth that is the alert threshold.
Information as to whether the automatic braking of the PCS control was performed.
An automatic braking activation point that is the location of the device-mounted vehicle when the automatic braking of the PCS control was started.
Automatic braking activation date and time that is the date and time when the automatic braking of the PCS control was started.
An automatic braking start vehicle speed VhBK that is the vehicle speed of the device-mounted vehicle when the automatic braking of the PCS control was started, and an automatic braking threshold time TBKth that is the automatic braking threshold.

As described above, the PCS activation information includes first information that identifies the point where the automatic braking was performed.

When the server 100a receives the PCS actuation information, it stores the PCS activation information in the information storage device 100b. Further, when the received PCS activation information indicates that the automatic braking was performed, the server 100a stores the automatic braking activation point identified by the PCS activation information as a frequent activation candidate point in the information storage device 100b.

In addition, when PCS actuation information is newly received, this PCS actuation information may indicate that the automatic braking was performed. At this time, when a predetermined frequent activation point registration condition is satisfied, the server 100a stores (registers) the automatic braking activation point identified by the PCS activation information in the information storage device 100b as a frequent activation point. For example, the frequent activation point registration condition is satisfied when the number of frequent activation candidate points stored (registered) in the information storage device 100b within the most recent predetermined period (for example, one year) out of the frequent activation candidate points located within the range near the automatic braking activation point identified by the newly received PCS activation information is equal to or larger than a first threshold Xth. When the automatic braking activation point is a point inside a certain intersection, the range near the automatic braking activation point means the range of the intersection. When the automatic braking activation point is not a point inside an intersection, and the range near the automatic braking activation point means the range of the radius N (m) centered on the automatic braking activation point.

The device DS transmits the current location of the host vehicle HV and a data request to the server 100a. When the server 100a receives the data request, it reads a “frequent activation point and a frequent activation candidate point” within a predetermined distance from the current location of the host vehicle HV from the information storage device 100b, and transmits them to the device DS. When the device DS receives a frequent activation point, it causes the notification ECU 60 to alert only once that the host vehicle HV is approaching the frequent activation point. On the other hand, the device DS does not provide such an alert “when it receives a frequent activation candidate point” or “when it receives neither a frequent activation point nor a frequent activation candidate point.”

The device DS also pre-pressurizes the brake fluid when it receives “either a frequent activation point or a frequent activation candidate point.” The operation of pre-pressurizing the brake fluid is an operation for reducing a delay period from when the brake actuator 51 is instructed to perform the automatic braking via the brake ECU 50 until the braking force is actually applied to the host vehicle HV. More specifically, the device DS performs, as the pre-pressurization operation, an operation of increasing the pressure of the brake fluid in the oil passage 52 and the hydraulic friction braking device 53 to such an extent that the friction braking force is not generated. The pre-pressurization operation is also referred to as pre-filling operation. The control to perform the pre-pressurization is also referred to as auxiliary control.

As described above, storage (registration) of the frequent activation point in the information storage device 100b is not performed as soon as the PCS activation information is received. The storage is performed only when there are a large number of frequent activation candidate points near the current automatic braking activation point identified by the received PCS activation information. Therefore, the frequent activation point is a point where the automatic braking is highly likely to be performed. Since the device DS provides an alert only when a frequent activation point is received from the server 100a, the alert is helpful for the driver of the host vehicle HV. When the device DS receives a frequent activation candidate point from the server 100a, it does not provide an alert, and performs only the pre-pressurization operation. Therefore, an alert that bothers the driver of the host vehicle HV is not provided frequently, and the host vehicle HV can be quickly decelerated if the automatic braking is performed.

The frequent activation candidate point and the frequent activation point each have a correlation with the level of possibility that the automatic braking is performed. That is, the level of possibility that the automatic braking is performed at the frequent activation point is higher than the level of possibility that the automatic braking is performed at the frequent activation candidate point. The information indicating the frequent activation candidate point and the frequent activation point is also collectively referred to as specific point-related information.

### Specific Operation

### Server Operation

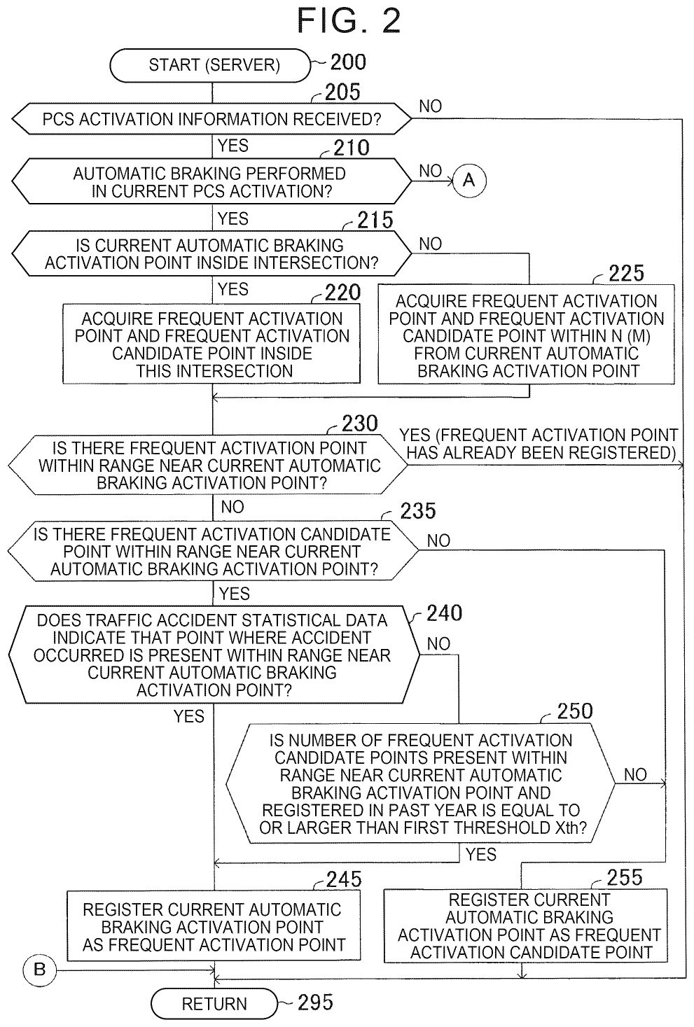

The server 100a executes a routine shown in FIG. 2 every predetermined period of time. Hereinafter, the “server 100a” is referred to as “server”, and the “step” is referred to as “S”.

At a predetermined timing, the server starts the process with S200 in FIG. 2 and proceeds to S205 to determine whether PCS activation information has been received from the device DS of the device-mounted vehicle.

When PCS actuation information has been received, the server proceeds to S210 and determines, based on the received PCS actuation information, whether the automatic braking was performed in the current PCS actuation.

When the automatic braking was performed in the current PCS activation, the servers proceed to S215. In S215, whether the current automatic braking activation point identified by the received PCS activation information is inside an intersection is determined based on the map information stored in the information storage device 100b. When the current automatic braking activation point is inside an intersection, the server proceeds to S220, and information on a “frequent activation point and a frequent activation candidate point” inside the intersection is read from the information storage device 100b. The process then proceeds to S230. When the current automatic braking activation point is not inside an intersection, the servers proceed from S215 to S225. In S225, the information of a “frequent activation point and a frequent activation candidate point” inside the circle of the radius N (m) centered on the current automatic braking activation point is read from the information storage device 100b. The radius N (m) is a product of the automatic braking start vehicle speed VhBK (m/s) and the automatic braking threshold time TBKth(s) in the current PCS activation or the sum of this product and a certain distance, but may be a predetermined distance. The servers then proceed to S230.

In S230, the server determines whether there is a frequent activation point in the range near the current automatic braking activation point. When the current automatic braking activation point is inside an intersection, the range near the current automatic braking activation point is the range of the intersection. When the current automatic braking activation point is not inside an intersection, the range near the current automatic braking activation point is the range of the circle of the radius N (m) centered on the current automatic braking activation point.

When there is no frequent activation point in the range near the current automatic braking activation point, the server proceeds to S235 and determines whether there is a frequent activation candidate point in the range near the current automatic braking activation point. When there is a frequent activation candidate point in the range near the current automatic braking activation point, the server proceeds to S240 and determines, based on the traffic accident statistical data, whether a point where an accident occurred is present in the range near the current automatic braking activation point.

When the condition in S240 is satisfied, the server proceeds to S245 and stores (registers) the current automatic braking activation point in the information storage device 100b as a frequent activation point. The server then proceeds to S295 and tentatively ends the routine.

On the other hand, when the condition in S240 is not satisfied, the servers proceed from S240 to S250. In S250, it is determined whether the number of frequent activation candidate points stored (registered) in the information storage device 100b in the most recent predetermined period (for example, one year) out of the frequent activation candidate points in the range near the current automatic braking activation point (i.e., the number of most recent registrations) is equal to or larger than the first threshold Xth. When the number of most recent registrations is equal to or larger than the first threshold Xth, the server proceeds to S245 described above, and stores (registers) the current automatic braking activation point in the information storage device 100b as a frequent activation point. The servers then proceed to S295.

When the server proceeds to S235 and the condition in S235 is not satisfied, the server proceeds from S235 to S255 and stores (registers) the current automatic braking activation point in the information storage device 100b as a frequent activation candidate point. The servers then proceed to S295. Further, when the server proceeds to S250 and the condition in S250 is not satisfied, the server proceeds from S250 to S255 and stores (registers) the current automatic braking activation point in the information storage device 100b as a frequent activation candidate point. The servers then proceed to S295.

When “No” in S205, the servers proceed directly to S295. Further, when the servers proceed to S230 and there is a frequent activation point in the range near the current automatic braking activation point, the servers proceed directly from S230 to S295.

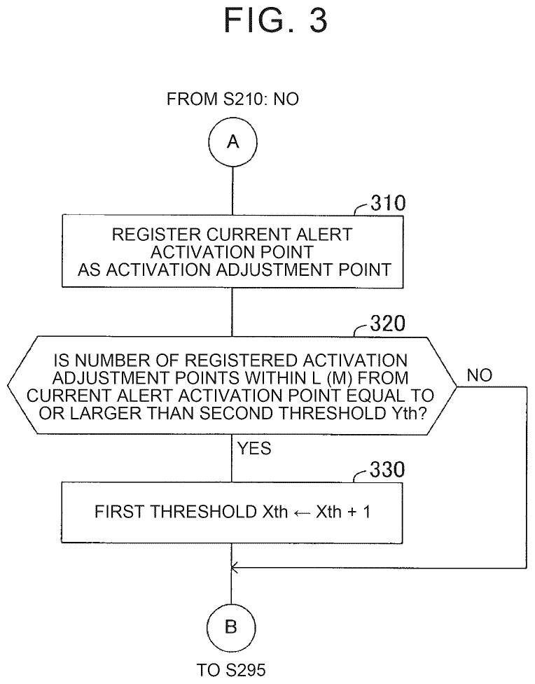

In addition, when the server proceeds to S210 and the automatic braking was not performed in the current PCS activation (i.e., only an alert was provided), the server proceeds from S210 to S310 in FIG. 3. In S310, the server stores (registers) the current alert activation point identified by the received PCS activation information in the information storage device 100b as an activation adjustment point. Next, in S320, the servers determine whether the number of activation adjustment points that are present inside the circle with the radius L (m) centered on the current alert activation point is equal to or larger than a second threshold Yth. When the condition in S320 is satisfied, the server proceeds to S330 and increments the first threshold Xth by “1.” The radius L (m) is the product of the alert start vehicle speed VhAL (m/s) in the current PCS activation and the alert threshold time TALth(s) or the sum of this product and a certain distance. However, the radius L (m) may be a predetermined distance. The servers then proceed to S295 in FIG. 2. As a result, a point where only an alert of the PCS control was provided and the automatic braking was not performed is less likely to be stored (registered) as a frequent activation point. This is because if the device DS erroneously recognizes an object and stores (registers) a point where only an alert is highly likely to be provided as a frequent activation point, there is a high possibility that a wrong alert may be provided. On the other hand, when the condition in S320 is not satisfied, the servers proceed directly from S320 to S295 in FIG. 2.

### Operation of Vehicle Control ECU 10

### 1. Notification and Pre-Pressurization Operation

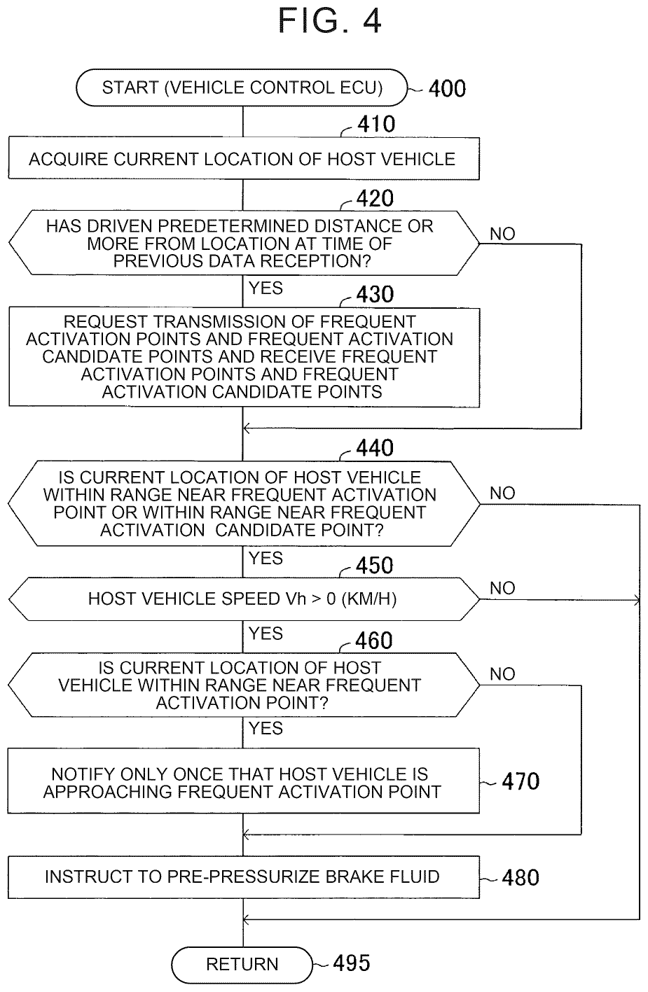

The CPU 10a of the vehicle control ECU 10 (hereinafter, simply referred to as “CPU”) executes the routines shown in the flowcharts in FIGS. 4 to 6 at predetermined intervals. Therefore, at a predetermined timing, the CPU starts the process from S400 in FIG. 4 and proceeds to S410 to acquire the present position of the host vehicle HV from the navigation ECU 70.

Next, the CPU proceeds to S420 and determines whether the host vehicle HV has traveled a predetermined distance or more since the last time the CPU received data from the server (i.e., the last time the data was acquired). As used herein, the data refers to data that identifies frequent activation points and frequent activation candidate points, which will be described later.

When the condition in S420 is satisfied, the CPU proceeds to S430 to transmit the current location of the host vehicle HV to the server and request the server for frequent activation points and frequent activation candidate points. In response to this request, the server reads, from the information storage device 100b, frequent activation points and frequent activation candidate points that are located within a threshold distance (for example, several hundreds of meters to several kilometers) from the current location of the host vehicle HV, and transmits information identifying these points (specific point-related information) to the host vehicle HV. The device DS receives the information identifying the frequent activation points and the frequent activation candidate points from the server, and stores the received information in the RAM 10c. S430 is also performed when the host vehicle HV is activated (started). The CPU then proceeds to S440. On the other hand, when the condition in S420 is not satisfied, the CPU proceeds directly from S420 to S440.

In S440, the CPU determines whether the current location of the host vehicle HV is either within the range near any of the received frequent activation points or within the range near any of the received frequent activation candidate points. As used herein, the range is the range of a circle with a predetermined alert distance centered on the host vehicle HV. When the condition in S440 is satisfied, the CPU proceeds to S450 to determine whether the host vehicle speed Vh is higher than “0” (i.e., whether the host vehicle HV is traveling).

When the host vehicle speed Vh is higher than “0 ,” the CPU proceeds to S460 and determines whether the current location of the host vehicle HV is within the range near any of the received frequent activation points. As used herein, the range is also the range of a circle with a predetermined alert distance centered on the host vehicle HV. When the condition in S460 is satisfied, it can be determined that the level of possibility that the automatic braking is newly performed is equal to or higher than a second level. Therefore, in this case, the CPU proceeds to S470, and instructs the notification ECU 60 to notify (alert) only once that the host vehicle HV is approaching a frequent activation point. This notification is a notification to the occupant of the host vehicle HV that the host vehicle HV is approaching a dangerous point where the automatic braking is frequently performed, and is provided by the alert display device 61 and/or the alert sound generation device 62. The CPU then proceeds to S480.

On the other hand, when the condition in S460 is not satisfied, the CPU proceeds directly from S460 to S480. When the condition in S440 is satisfied and the condition in S460 is not satisfied, it can be determined that the level of possibility that the automatic braking is newly performed is lower than the second level but is equal to or higher than a first level lower than the second level. When the condition in S460 is satisfied, the level of possibility that the automatic braking is newly performed is equal to or higher than the second level, and therefore, the level of possibility is equal to or higher than the first level.

In S480, the CPU transmits an instruction to the brake ECU 50 to perform the operation of pre-pressurizing the brake fluid (i.e., auxiliary control), and then proceeds to S495 to temporarily end the routine.

For convenience, the control to perform the pre-pressurization in S480 without giving the notification in S470 is sometimes referred to as first control. The control to perform both the notification in S470 and the pre-pressurization in S480 is sometimes referred to as second control.

Further, when “No” in either S440 or S450, the CPU proceeds directly to S495 from the step in which the determination result is “No.”

### 2. End of Pre-Pressurization Operation

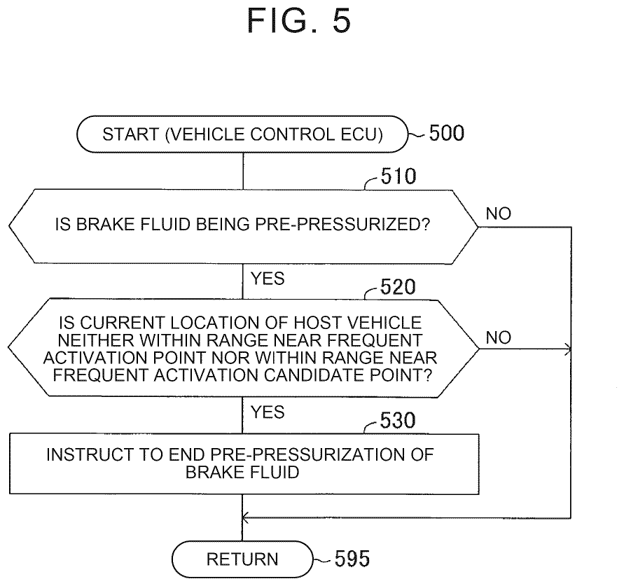

At a predetermined timing, the CPU starts the process from S500 in FIG. 5 and proceeds to S510 to determine whether the brake fluid is currently being pre-pressured. When the condition in S510 is satisfied, the CPU proceeds to S520 and determines whether the current location of the host vehicle HV is neither within the range near a frequent activation point nor within the range near a frequent activation candidate point.

When the condition in S520 is satisfied, the CPU proceeds to S530 and transmits an instruction to the brake ECU 50 to end the operation of pre-pressurizing the brake fluid. The CPU then proceeds to S595 to tentatively end the routine. When “No” in S510 or S520, the CPU proceeds to S595 from the step in which the determination result is “No”.

### 3. Execution of Collision Avoidance Control (PCS) and Transmission of PCS Activation Information

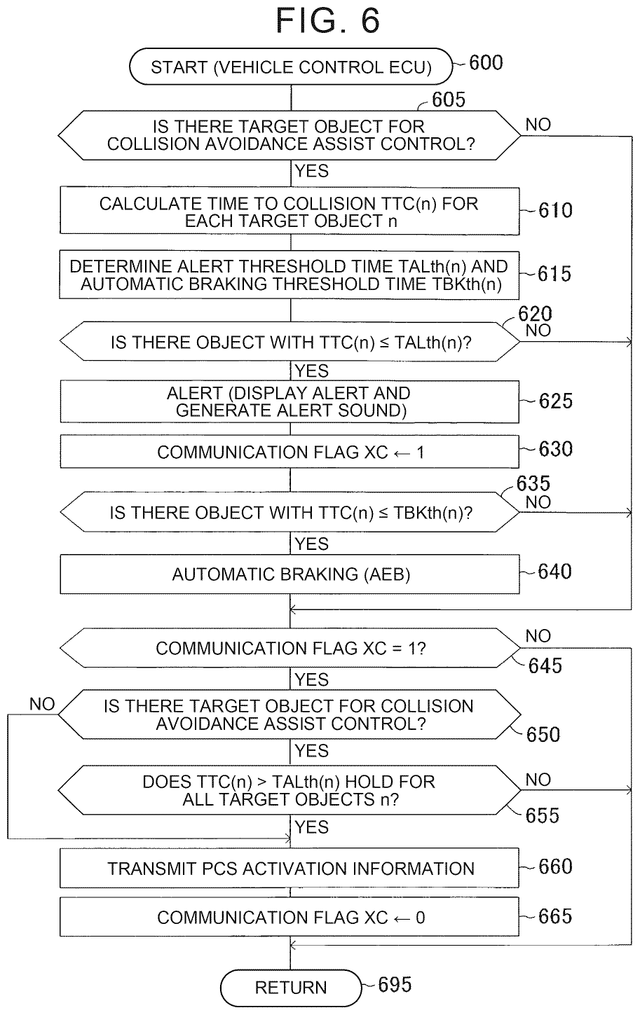

At a predetermined timing, the CPU starts the process from S600 in FIG. 6 and proceeds to S605 to determine whether there is an object within the range of an expected host vehicle travel region that is a region ahead of the host vehicle HV. The expected host vehicle travel region is a region through which the vehicle body of the host vehicle HV passes when the host vehicle HV travels at the current vehicle speed for a predetermined time in the current direction of travel of the host vehicle HV. An object located in the expected host vehicle travel region is an object that is subjected to collision avoidance, and is hereinafter simply referred to as “target object.”

When there is a target object, the CPU proceeds to S610 and calculates the time to collision TTC(n) for each target object n. The time to collision TTC(n) is calculated by dividing the distance L(n) between the host vehicle HV and the target object n by the relative velocity Vr(n) of the target object n.

The CPU then proceeds to S615 to determine an alert threshold time TALth(n) and an automatic braking threshold time TBKth(n). These values may be predetermined fixed values, and may be changed based on, for example, the type of the target object n and the overlap ratio between the target object (n) and the predicted traveling area of the host vehicle. The alert threshold time TALth(n) is greater than the automatic braking threshold time TBKth(n).

Next, the CPU proceeds to S620, and determines whether the above alert condition is satisfied by determining whether there is an object n whose time to collision TTC(n) is equal to or less than the alert threshold time TALth(n). The time when the time to collision TTC(n) becomes equal to or less than the alert threshold time TALth(n) is the time when the risk of collision between the object n and the host vehicle HV reaches the alert threshold. When there is such an object n, the CPU proceeds to S625 and transmits an indication to the notification ECU 60 to provide an alert for collision avoidance. Next, the CPU proceeds to S630 and sets a communication flag XC to “1”. The communication flag XC is set to “0” when the host vehicle HV is started.

Next, the CPU proceeds to S635, and determines whether the above collision avoidance condition is satisfied by determining whether there is an object n whose time to collision TTC(n) is equal to or less than the automatic braking threshold time TBKth(n). The time when the time to collision TTC(n) becomes equal to or less than the automatic braking threshold time TBKth(n) is the time when the risk of collision between the object n and the host vehicle HV reaches the automatic braking threshold.

Where there is such an object n, the CPU proceeds to S640 and transmits instructions to the powertrain ECU 40 and the brake ECU 50 to perform the automatic braking. The CPU then proceeds to S645. When “No” in any of S605, S620 and S635, the CPU proceeds directly to S645 from the step in which the determination result is “No.”

In S645, the CPU determines whether the communication flag XC is “1.” When the communication flag XC is “1,” the CPU proceeds to S650 and determines whether there is currently a target object. When there is no target object, the CPU proceeds to S660. When there is a target object, the CPU proceeds to S655 to determine whether the time to collision TTC(n) is greater than the alert threshold time TALth(n) for all target objects n. When the condition in S655 is satisfied, the CPU proceeds to S660.

The CPU transmits the above PCS activation information to the server in S660 and proceeds to S665 to set the communication flag XC to “0 .” The CPU then proceeds to S695 and tentatively ends the routine. When “No” in S645 or 655, the CPU proceeds to S695 from the step in which the determination result is “No.”

As described above, the device DS and the external device 100 can perform beneficial control for collision avoidance so as not to frequently bother an occupant of the host vehicle HV. The present disclosure is not limited to the above embodiment, and various modifications can be adopted within the scope of the present disclosure. For example, the device DS can be applied to autonomous vehicles in which the driving mode has been switched from an autonomous driving mode to a manual driving mode by the driver.

What is claimed is:

1. A vehicle control device including
a controller configured to acquire object information indicating a relative relationship between an object located in a direction of travel of a host vehicle and the host vehicle and to perform automatic braking when the controller determines, based on the object information, that a risk of collision between the host vehicle and the object is equal to or higher than an automatic braking threshold, and
a communication device configured to communicate with an external device located outside the host vehicle, wherein the controller is configured to
receive specific point-related information from the external device via the communication device, the specific point-related information being information identifying a point where the automatic braking was performed in a past and having a correlation with a level of possibility that the automatic braking is newly performed at the point, and
when the host vehicle approaches the point identified by the specific point-related information, perform either first control or second control according to the specific point-related information.

2. The vehicle control device according to claim 1, wherein the controller is configured to
when the level of possibility that the automatic braking is newly performed as indicated by the specific point-related information is equal to or higher than a first level, perform auxiliary control as the first control, the auxiliary control being control for reducing an amount of time from when an instruction to perform the automatic braking is transmitted to a braking device of the host vehicle until a braking force actually starts to be applied to the host vehicle, and
when the level of possibility that the automatic braking is newly performed as indicated by the specific point-related information is equal to or higher than a second level that is higher than the first level, perform, as the second control, both the auxiliary control and notification to an occupant of the host vehicle that the host vehicle is approaching a dangerous point.

3. The vehicle control device according to claim 2, wherein:
the braking device includes a friction braking device configured to be driven by a hydraulic pressure of a brake fluid; and
the auxiliary control is control to increase the hydraulic pressure of the brake fluid to such an extent that a braking force from the friction braking device is not applied to the host vehicle.

4. An external device including an information storage device and a server configured to transmit and receive information to and from a vehicle by communication, wherein the server is configured to
receive first information from the vehicle, the first information being information identifying a point where automatic braking for avoiding a collision between the vehicle and an object located in a direction of travel of the vehicle was performed by the vehicle,
register, in the information storage device, the point identified by the received first information as a frequent activation candidate point,
when the first information is newly received and a predetermined number or more of the frequent activation candidate points have already been registered within a predetermined range near the point where the automatic braking was performed as identified by the newly received first information, register, in the information storage device, the point where the automatic braking was performed as identified by the newly received first information as a frequent activation point, and
transmit the registered frequent activation candidate point and the registered frequent activation point to the vehicle.

5. The external device according to claim 4, wherein the server is configured to, when the first information is newly received and a point where an accident occurred in a past is determined to be present within the range near the point where the automatic braking was performed as identified by the newly received first information, register, in the information storage device, the point where the automatic braking was performed as identified by the newly received first information as the frequent activation point.
